(19) United States
(12) Patent Application Publication
(10) Pub. No.: US 2020/0354016 A1
(43) Pub. Date: Nov. 12, 2020

(54) METHOD FOR PRODUCING A BICYCLE COMPONENT, BICYCLE COMPONENT AND BICYCLE CHAINSET

(71) Applicant: Saint Jean Industries, Saint-Jean-d'Ardières (FR)

(72) Inventors: Emile Thomas DI SERIO, Chenas (FR); Lionel DUPERRAY, Saint Jean D'Ardieres (FR); Pierre Loup JUDAS, Saint Germain au Mont d'Or (FR)

(73) Assignee: Saint Jean Industries, Saint-Jean-d'Ardières (FR)

(21) Appl. No.: 16/965,040

(22) PCT Filed: Feb. 13, 2019
(86) PCT No.: PCT/FR2019/050319

§ 371 Date: Jul. 27, 2020

(30) Foreign Application Priority Data
Feb. 13, 2018 (FR) 1851191

(51) Int. Cl. B62M 3/00; B21J 5/00; B21J 5/06; B21K 17/00; B21K 21/08

(52) U.S. Cl. CPC B62M 3/00; B21J 5/002; B23P 15/00; B21K 17/00; B21K 21/08; B21J 5/06

(57) ABSTRACT

The present invention concerns a method for producing a bicycle component (10), characterised in that it comprises the following consecutive operations: a step of producing a part (15) comprising an inner cavity (52) that is open on one side; a step of positioning a plate (60) on the part (15) in order to cover the cavity (52); and a step of securing the plate (60) to the part (15) in order to obtain the bicycle component (10). The invention also concerns a bicycle component (10) and a bicycle chainset.

The present invention relates to a method for producing a hollow bicycle component. The invention also relates to a bicycle component and a bicycle chainset.

In the field of cycling, and especially competitive cycling, the most demanding users are continually seeking to reduce the weight of their equipment. At the same time, structural parts and parts of the transmission must withstand mechanical stresses and have good rigidity. These contradictory characteristics necessitate searching for innovative solutions to satisfy users.

The aim of the present invention is thus to propose an improved method for producing a bicycle component.

To this end, an object of the invention is a method for producing a bicycle component, characterized in that it comprises the following consecutive steps:
a step of producing a part comprising an inner cavity that is open on one side;
a step of positioning a plate on the part in order to cover the cavity; and
a step of securing the plate to the part, in order to obtain the bicycle component.

Thus, the invention makes it possible to improve the relationship between the rigidity and the weight of the component. The method makes it possible to propose a component having the same mechanical strength with a lighter weight, compared to existing solutions.

Another object of the invention is a bicycle component, comprising a part comprising an inner cavity that is open on one side, characterized in that the component comprises a flat plate secured to the part, covering the cavity.

According to other advantageous features of the invention, considered alone or in combination:
The production of the part comprises a foundry operation.
The production of the part comprises a forging operation.
The production of the part comprises a foundry operation followed by a forging operation, according to the hybrid Cobapress process.
The production of the part comprises an extrusion-lamination operation.
The production of the part comprises an additive manufacturing operation.
The inner cavity is produced in the part without an additional machining operation.
The inner cavity is produced in the part by an additional machining operation.
The operation of machining the inner cavity in the part, the step of positioning the plate on the part, and the step of securing the plate to the part are carried out on the same machine.
The plate is planar, has a constant thickness, and comprises two peripheral ridges formed with a right angle.
In the step of producing the part, a shoulder for receiving the plate is formed at the upper edge of the cavity.
On the whole upper edge of the cavity, the shoulder forms a right-angled step with two peripheral ridges formed with a right angle.
The shoulder has a depth equal to the thickness of the plate.
The shoulder is produced during the same machining operation as the inner cavity or as the finishing of the inner cavity.
The plate is produced by laser cutting.
After the step of positioning the plate on the part against the shoulder, a planar outer face of the plate and a planar outer face of the part together form a planar surface.
The part comprises branches for receiving a chainring.
The part comprises four branches arranged in an X.
The branches are formed as a single piece with the part.
The branches are machined on the part.
The branches are molded on the part.
The branches are forged on the part.
The branches are applied to the part in order to form the component.
The plate entirely covers the cavity.
The cavity is leaktight. Preferably, this leaktightness is obtained during the securing of the plate on the part. Alternatively, this leaktightness may be obtained by a seal or a plug, in particular in the case in which the component incorporates electronic elements.
The securing step is carried out by welding, preferably friction stir welding.
The securing step is carried out by bonding.
The method comprises a final step of finishing, in order to give the component a desired outer appearance.
The finishing step comprises an operation of deburring the weld produced between the part and the plate.
The finishing step comprises an operation of resurfacing the component at the weld produced between the part and the plate, for example by milling or sanding.
The finishing step comprises an operation of machining the outer contours of the part.
The finishing step comprises a heat treatment operation.
The finishing step comprises a surface treatment operation.

Between the step of producing the part and the step of positioning the plate on the part, the method comprises a step of inserting at least one electronic component into the inner cavity. The electronic component may be an LED, a sensor, a GPS chip, etc.

Another object of the invention is a bicycle chainset, comprising:
a first crank consisting of a first component, as mentioned above;
a second crank consisting of a second component, as mentioned above;
a chainring mounted on the first crank; and
an axle connecting the first crank and the second crank.

In the remainder of the description, the component in accordance with the invention is a crank. In the context of the invention, other components of a bicycle, such as a frame, a stem, or a support for the batteries or motor of an electric bicycle, can be conceived of.

The invention will be better understood upon reading the following description, given solely as a non-limiting example, and made with reference to the accompanying figures wherein:

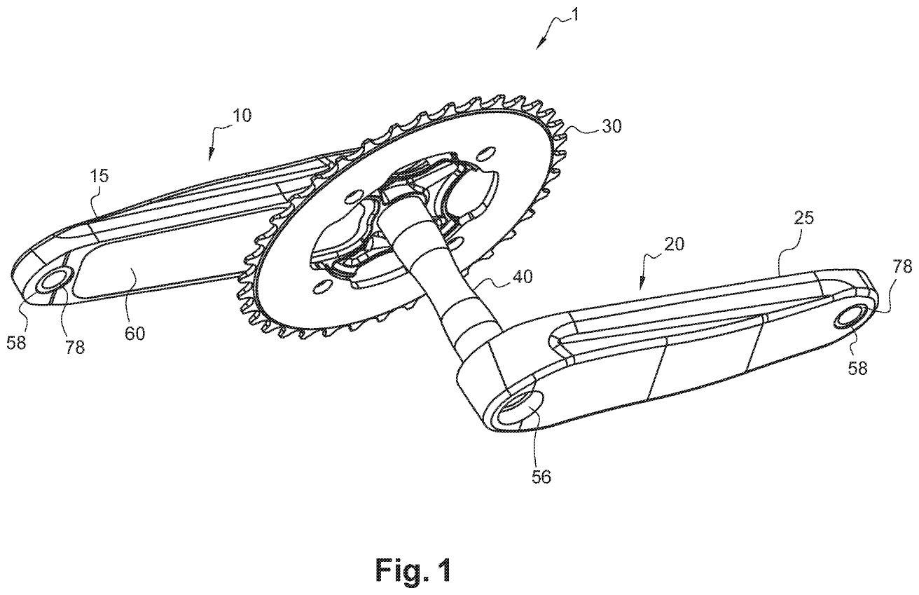

FIG. 1 is a perspective view of the chainset in accordance with the invention, comprising a chainring, an axle and two cranks;

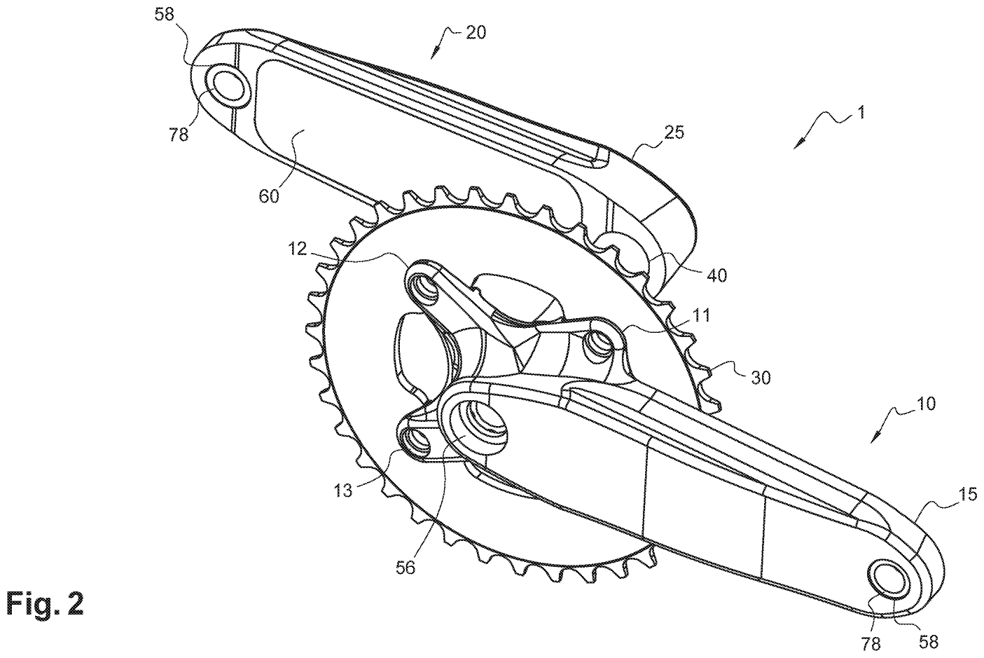

FIG. 2 is another perspective view of the chainset, from the chainring side;

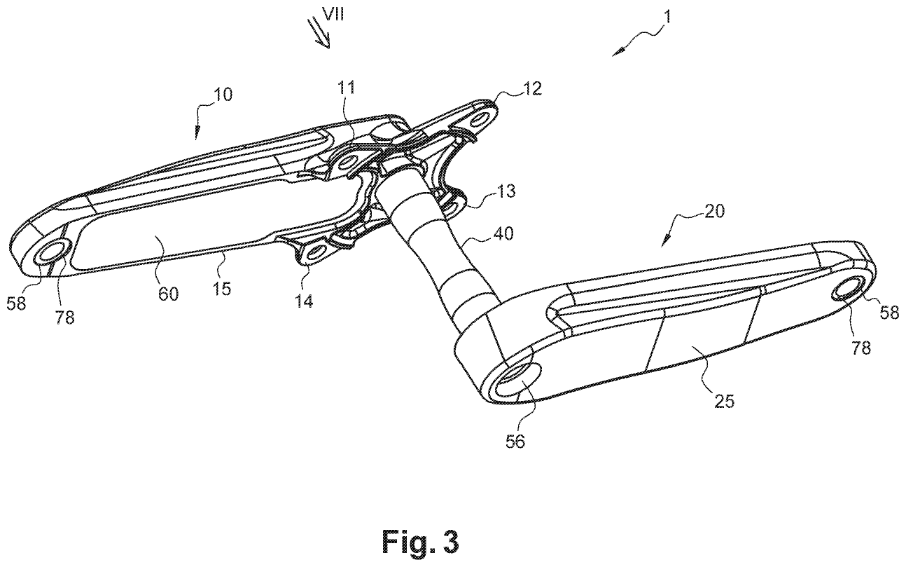

FIG. 3 is a similar view to FIG. 1, without the chainring;

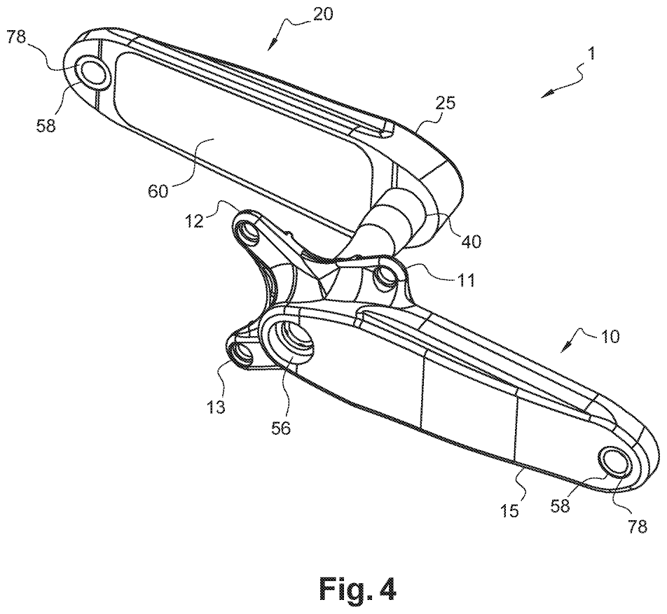

FIG. 4 is a similar view to FIG. 2, without the chainring;

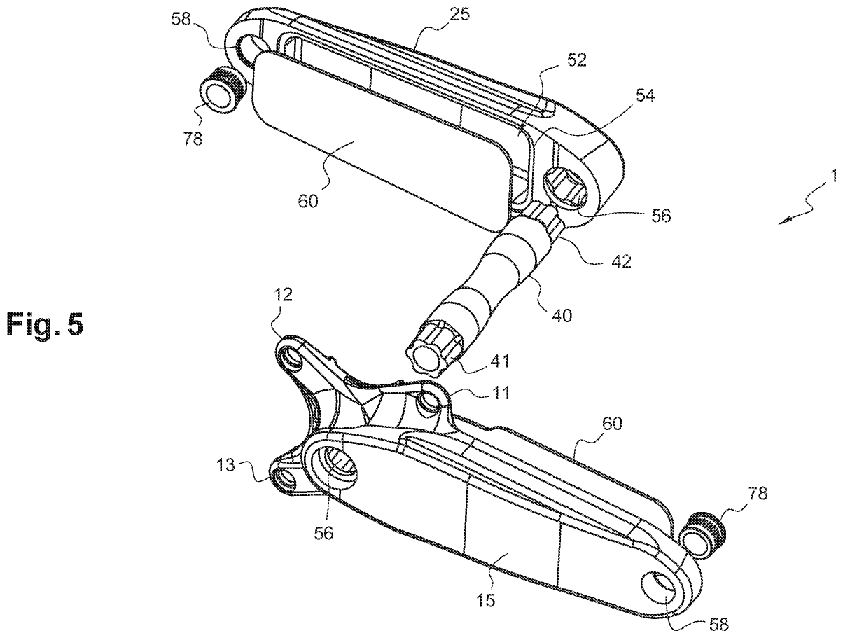

FIG. 5 is an exploded view of the chainset, corresponding to FIG. 4;

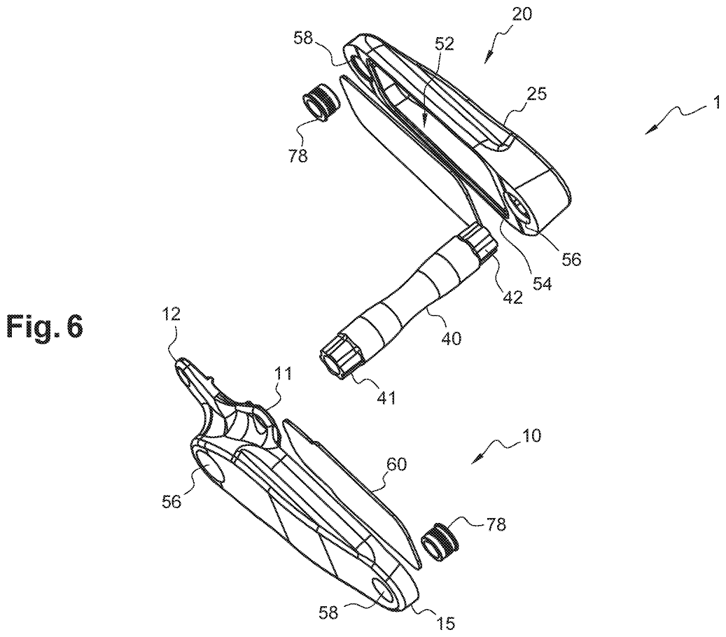

FIG. 6 is another exploded view of the chainset;

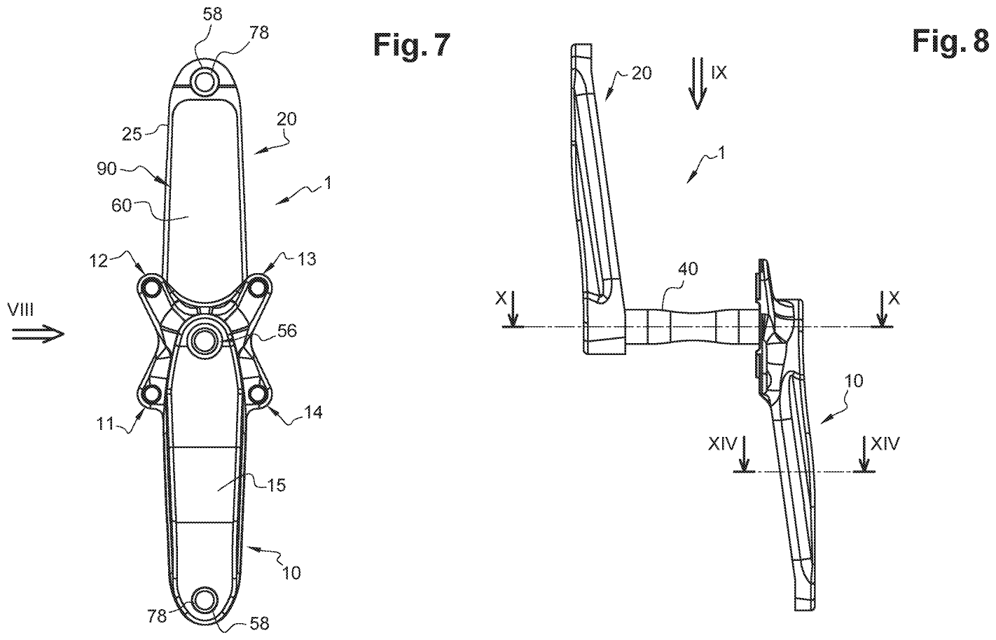

FIG. 7 is a side view of the chainset, according to arrow VII in FIG. 3;

FIG. 8 is a top view of the chainset, according to arrow VIII in FIG. 7;

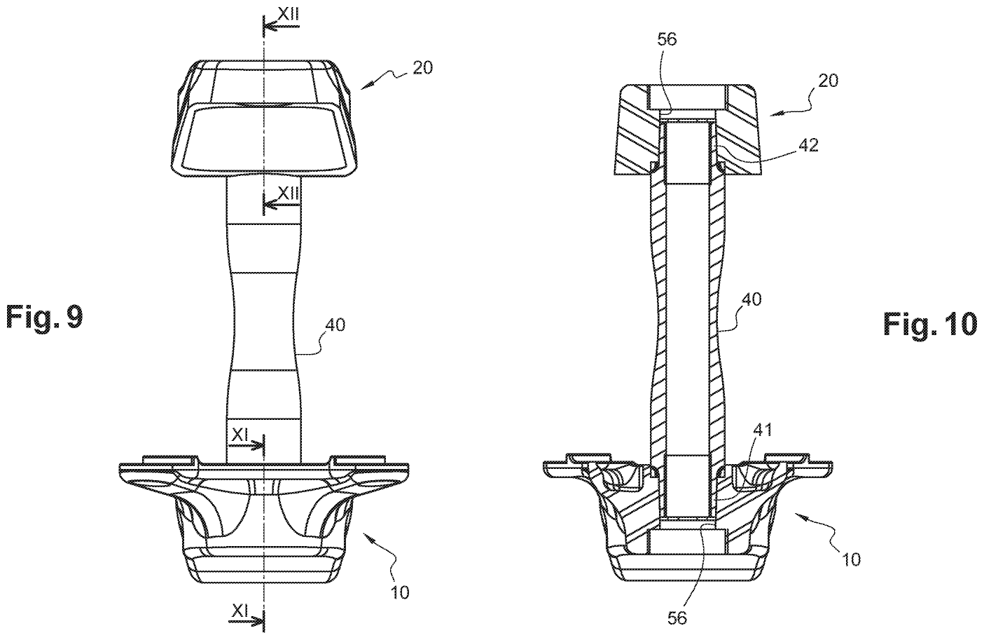

FIG. 9 is a front view of the chainset, according to arrow IX in FIG. 8;

FIG. 10 is a sectional view along line X-X in FIG. 9;

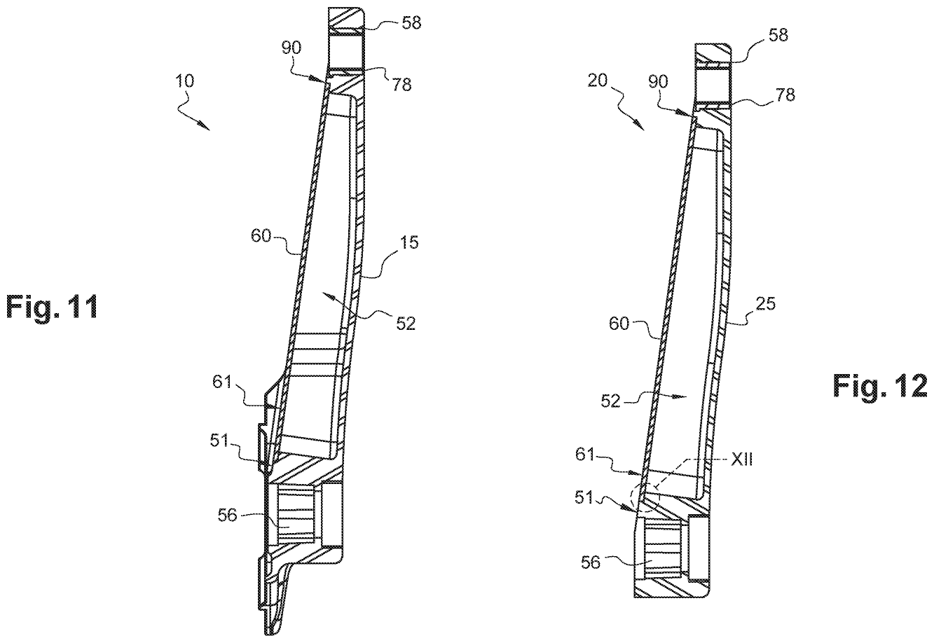

FIG. 11 is a sectional view along line XI-XI of the crank comprising branches for receiving the chainring;

FIG. 12 is a sectional view along line XII-XII of the other crank;

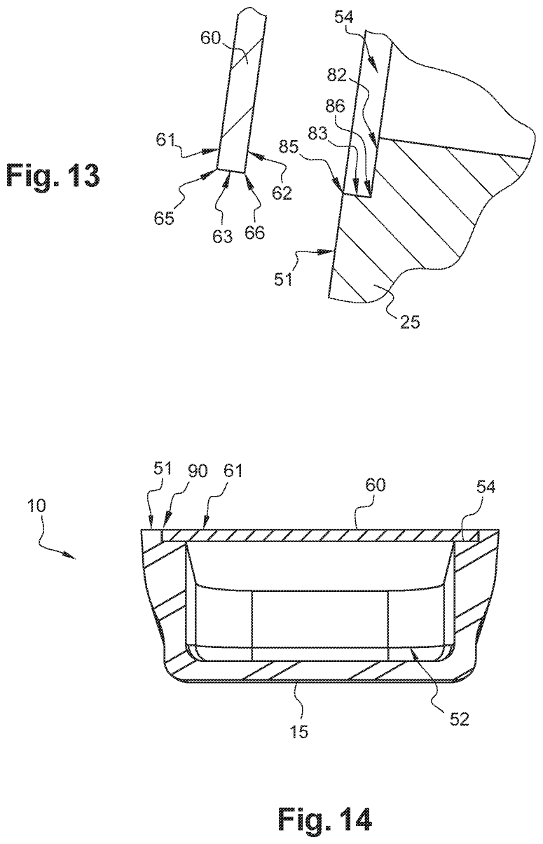

FIG. 13 is a larger scale view of the detail XII in FIG. 12, showing the plate and the shoulder before assembly;

FIG. 14 is a sectional view along line XIV-XIV of the crank comprising the branches;

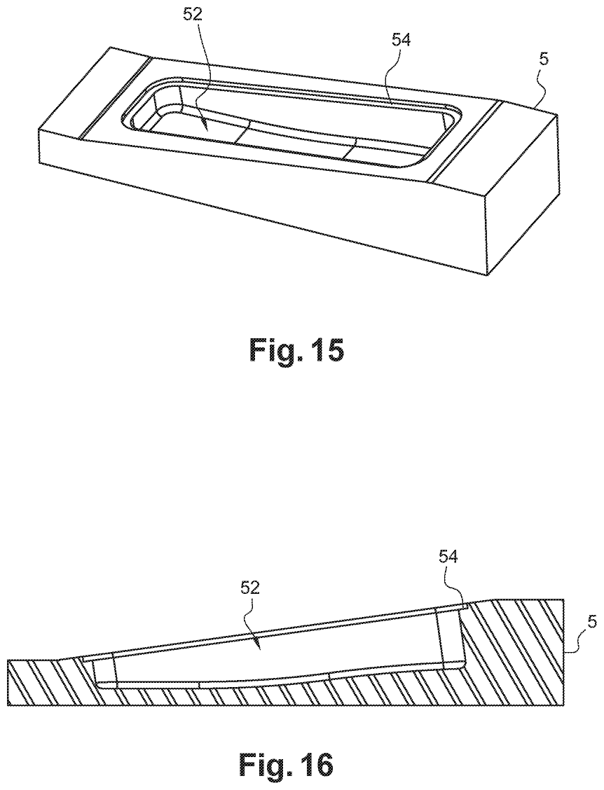

FIG. 15 is a perspective view of a constituent part of one of the cranks, during manufacture, after the machining of a cavity into a block of material; and

FIG. 16 is a longitudinal section of the part of FIG. 15.

FIGS. 1 to 10 show a chainset 1 in accordance with the invention, comprising two cranks 10, 20, an axle 40 connecting them, and a chainring 30 attached to one of the cranks 10. FIGS. 11 to 16 show only the cranks 10 and 20, constituting components in accordance with the invention.

According to the invention, each crank 10/20 comprises a base part 15/25 comprising a planar outer face 51 and an inner cavity 52 which is open at the face 51, on the side of the part 15/25. The cavity 52 is entirely covered by a plate 60 in order to make the cavity 52 leaktight.

The plate 60 is planar and has a constant thickness between the two flat faces 61 and 62 thereof. The plate 60 comprises a lateral surface 63 which extends over the entire periphery thereof, perpendicularly to the faces 61 and 62. The plate 60 comprises two ridges 65 and 66 which extend over the entire periphery thereof, respectively between the surfaces 61 and 63 and between the surfaces 62 and 63. Each ridge 65 and 66 is formed with a right angle, as can be seen in a sectional plane perpendicular to the plane of the plate 60.

The cavity 52 has a shoulder 54 formed in the upper edge thereof, with a depth equal to the thickness of the plate 60. The shoulder 54 forms a right-angled step. The shoulder 54 comprises a planar surface 82 provided to receive the planar inner face 62 of the plate 60 in planar bearing, and a lateral surface 83 which extends over the entire periphery thereof, perpendicular to the surface 82. The shoulder 54 comprises two ridges 85 and 86 which extend over the entire periphery thereof, respectively between the face 51 and the surface 83 and between the surfaces 82 and 83. Each ridge 85 and 86 is formed with a right angle, as can be seen in a sectional plane perpendicular to the plane of the shoulder 54.

After positioning the plate 60 on the part 15/25 against the shoulder 54, the planar outer face 61 of the plate 60 and the planar outer face 51 of the part 15/25 together form a planar surface.

The part 15/25 and the plate 60 are secured by connecting means 90, for example a weld or adhesive. The connecting means 90 make it possible to secure the face 51, the surface 83 and the ridge 85 of the part 15/25, on the one hand, to the face 61, the surface 63 and the ridge 65 of the plate 60, on the other hand.

The elements 52, 54 and 60 of each crank 10/20 have different dimensions but comprise the same references for the purpose of simplicity.

The base part 15/25 of each crank 10/20 also comprises two openings 56 and 58.

The opening 56 is designed for the securing of the axle 40. The opening 56 has an internal relief formed to protrude, which is complementary to the relief formed at the ends 41 and 42 of the axle 40. In the example of the figures, the relief of the opening 56 has six rounded hollows, while the relief of the ends 41 and 42 has six rounded raised areas.

The opening 58 is provided to receive a brace 78 for securing a pedal, not shown.

The complementary reliefs of the ends 41 and 42 of the axle 40 and of the openings 56 of the parts 15/25 may have different configurations without departing 25 from the scope of the invention. For example, the reliefs may have planar facets, enabling the press fitting thereof.

The axle 40 preferably has a tubular, i.e. hollow, section, as shown in FIG. 10. Alternatively, the axle 40 may have a solid section.

The crank 10 comprises four branches 11, 12, 13 and 14, for receiving the chainring 30. The branches 11-14 are formed as a single piece on the base part 15. The branches 11-14 can be machined, molded or forged on the part 15. Advantageously, the branches 11-14 can be machined on a CNC (computer numerical control) machine tool.

Alternatively, the branches 11-14 can be independent of the crank 10, that is to say applied to the base part 15.

Preferably, the base part 15/25 and the plate 60 are made of metal. Further preferably, the metal is an aluminum alloy.

Alternatively, the part 15/25 and/or the plate 60 may be made of plastic. Alternatively, the part 15/25 and/or the plate 60 may be made of composite material, such as a carbon fiber reinforced plastic (CFRP).

The plate 60 may be produced by laser cutting. This makes it possible to ensure a high level of precision in the dimensions of the plate and in the perpendicularity between the lateral surface 63 and the planar faces 61 and 62.

The plate 60 may be secured to the base part 15/25 by employing a welding technique, preferably the friction stir welding technique. Other techniques are also possible, such as CMT welding (Cold Metal Transfer), TIG welding (Tungsten Inert Gas), or the like.

Alternatively, the part 15/25 and the plate 60 may be secured to one another by bonding (for example: epoxy type adhesive).

Preferably, the part 15/25 and the plate 60 are produced from the same material. Alternatively, the part 15/25 and the plate 60 may be produced from different materials.

A method for producing a bicycle component according to the invention comprises the consecutive steps described below.

Firstly, the method comprises a step of producing a part 5 comprising an inner cavity 52 that is open on one side, as shown in FIG. 15.

For example, the production of the part 5 may comprise:
a foundry operation;
a forging operation;
a foundry operation followed by a forging operation, according to the hybrid Cobapress process (described in particular in patent EP0119365);
an extrusion-lamination operation; or
an additive manufacturing operation.

In particular, the part 5 may be produced from a preform, i.e. a block of raw material, obtained by foundry, forging, foundry+forging, extrusion, additive manufacturing, etc.

The inner cavity 52 may be produced in the part 5 without an additional machining operation. The preform may have a recess obtained by foundry, forging, foundry+forging, additive manufacturing, and having the final form of the cavity 52.

Alternatively, the cavity 52 may be partially produced in the part 5 by a machining operation. The preform may have a recess, requiring additional machining in order to obtain the final form of the cavity 52.

According to another alternative, the cavity 52 may be entirely produced in the part 5 by a machining operation. The preform may be devoid of a recess before this machining. The cavity 52 is entirely machined in the preform in order to form the part 5.

The part 5 also comprises a shoulder 54 formed at the upper edge of the cavity 52. Preferably, the shoulder 54 is machined in the part 5, so as to form a right-angled step, with a planar surface for receiving the plate 60.

At this stage, the method may comprise a step of inserting one or more electronic components into the cavity 52. The electronic component may be an LED, a sensor, a GPS chip, etc.

Subsequently, a plate 60 is positioned on the part 5 in order to cover the cavity 52. The plate 60 is secured to the part 5, for example by welding or by bonding. The plate 60 is preferably secured to the part 5 by friction stir welding, then the weld is machined in a finishing step.

After positioning the plate 60 on the part 5 against the shoulder 54, a planar outer face 61 of the plate 60 and a planar outer face 51 of the part 5 together form a planar surface.

The friction stir welding technique makes it possible to weld without adding material, and therefore to save on weight, which is an important parameter in the field of cycling. This weld further makes it possible to have good mechanical properties. Finally, from an aesthetic perspective, this weld is virtually invisible after resurfacing, for example by milling or sanding.

Preferably, the shoulder 54 forms a right-angled step on the whole upper edge of the cavity 52, with two peripheral ridges 85 and 86 formed with a right angle, the plate 60 comprises two peripheral ridges 65 and 66 formed with a right angle, and the shoulder 54 has a depth equal to the thickness of the plate 60.

The right-angled contact between the plate 60 and the shoulder 54 makes it possible to ensure a highly precise adjustment, which is particularly advantageous for carrying out the friction stir welding. Moreover, the right-angled counter-bearing makes it possible to oppose the force applied perpendicularly to the plate 60 during the friction stir welding, and thereby to avoid deforming the plate 60.

Finally, the method may comprise a finishing step to give the component a desired outer appearance, in particular to lighten the weight of the component and give it the desired form from an aesthetic perspective. The finishing step may comprise an operation of deburring the weld produced between the part 5 and the plate 60. The finishing step may comprise an operation of machining the outer contours of the part 5. The finishing step may comprise a step of heat treatment and/or surface treatment.

At this stage, the part 5 forms the part 15 or 25, respectively of the crank 10 or 20.

Alternatively, it is possible to not carry out finishing machining of the part 5 after securing the plate 60. In this case, it is conceivable to give the part 5 its desired outer appearance, in particular to give it the desired form from an aesthetic perspective, directly in the first step of producing the part 5.

Advantageously, the operations for machining the part 5, and also the steps of positioning and securing the plate 60 to the part 5 may be carried out on the same machine, in particular a CNC machine tool. The reduction in the number of machines, and in the number of displacements of the part 5 between different machines, makes it possible to save time and money.

Moreover, the bicycle component can be configured differently from FIGS. 1 to 16 without departing from the scope of the invention, which is defined by the claims.

In particular, the component can be of any type suitable for the intended application. Different bicycle components, such as a frame, a stem, or a support for the batteries or motor of an electric bicycle, can be obtained by the method according to the invention.

In a variant not shown, the plate 60 can cover only a portion of the cavity 52.

According to another variant not shown, the base part 5 is machined to obtain two cavities 52, one on each side. Thus, the bicycle component comprises two plates 60 arranged facing each other.

Alternatively, the part 5 may be devoid of a shoulder 54. A surface of the part 5 is machined at the edge of the cavity 52, then the plate 60 is secured to this surface. In other words, after the operation of positioning the plate 60 on the part 5, the plate 60 overhangs the surface of the part 5.

According to another variant not shown, at least one electronic component is arranged in the cavity 52. For example, the electronic component can be a GPS chip for geolocating the component according to the invention. Alternatively, the electronic component may be a force sensor communicating with a propulsion system of an electronic bicycle.

According to a particular embodiment, the bicycle component may be a crank provided with an electric battery electrically connected to a light-emitting diode (LED). The diode is placed on the outside of the crank, in order to make nighttime use of the bicycle safe.

According to another particular embodiment, the electronic component may be an RFID chip for the identification of the bicycle component.

Moreover, the technical characteristics of the various embodiments and variants mentioned above can, in whole or for some of them, be combined with each other. Thus, the bicycle component can be adapted in terms of cost, functionalities and performance.

1. A method for producing a bicycle component (10; 20), wherein the method comprises the following consecutive steps:
a step of producing a part (15; 25) comprising an inner cavity (52) that is open on one side;
a step of positioning a plate (60) on the part (15; 25) in order to cover the cavity (52); and
a step of securing the plate (60) to the part (15; 25), in order to obtain the bicycle component (10; 20).

2-6. (canceled)

7. The method according to claim 1, wherein the inner cavity (52) is produced in the part (15; 25) without an additional machining operation.

8. The method according to claim 1, wherein the inner cavity (52) is produced in the part (15; 25) by an additional machining operation.

9. The method according to claim 8, wherein the operation of machining the inner cavity (52) in the part (15; 25), the step of positioning the plate (60) on the part (15; 25), and the step of securing the plate (60) to the part (15; 25) are carried out on the same machine.

10. The method according to claim 1, wherein the plate (60) is planar, has a constant thickness, and comprises two peripheral ridges (65, 66) formed with a right angle.

11. The method according to claim 1, wherein, in the step of producing the part (15; 25), a shoulder (54) for receiving the plate (60) is formed at the upper edge of the cavity (52).

12. The method according to claim 11, wherein, on the whole upper edge of the cavity (52), the shoulder (54) forms a right-angled step.

13. The method according to claim 11, characterized in that wherein the shoulder (54) has a depth equal to the thickness of the plate (60).

14. The method according to claim 11, wherein, after the step of positioning the plate (60) on the part (15; 25) against the shoulder (54), a planar outer face (61) of the plate (60) and a planar outer face (51) of the part (15; 25) together form a planar surface.

15-19. (canceled)

20. The method according to claim 1, wherein, between the step of producing the part (15; 25) and the step of positioning the plate on the part (15; 25), the method comprises a step of inserting an electronic component into the inner cavity (52).

21. A bicycle component (10; 20), comprising a part (15; 25) comprising an inner cavity (52) that is open on one side, wherein the bicycle component (10; 20) comprises a flat plate (60) secured to the part (15; 25), covering the cavity (52).

22. The component (10; 20) according to claim 21, wherein the plate (60) is planar, has a constant thickness, and comprises two peripheral ridges formed with a right angle.

23. The component (10; 20) according to claim 21, wherein the part (15; 25) comprises a shoulder (54) for receiving the plate (60) formed at the upper edge of the cavity (52).

24. The bicycle component (10; 20) according to claim 23, wherein, on the whole upper edge of the cavity (52), the shoulder (54) forms a right-angled step.

25. The bicycle component (10) according to claim 21, wherein the bicycle component (10) comprises branches (11, 12, 13, 14) for receiving a chainring (30), said branches (11, 12, 13, 14) being formed as a single piece on the part (15).

26. A bicycle chainset (1), comprising:
a first crank (10) consisting of a first bicycle component according to claim 21;
a second crank (20) consisting of a second bicycle component according to claim 21;
a chainring (30) mounted on the first crank (10); and
an axle (40) connecting the first crank (10) and the second crank (20).

27. The bicycle chainset according to claim 26, wherein the second bicycle component comprises branches for receiving a chainring, said branches being formed as a single piece on the part of the second bicycle component.
